(19) United States
(12) Patent Application Publication
(10) Pub. No.: US 2002/0184516 A1
(43) Pub. Date: Dec. 5, 2002

(54) Virtual object access control mediator

(76) Inventors: Douglas LaVell Hale, Orem, UT (US); Peter Kendrick Boucher, Orem, UT (US); Mark Gordon Gayman, Orem, UT (US)

Correspondence Address: SAWYER LAW GROUP LLP, P.O. Box 51418, Palo Alto, CA, 94303, US

(21) Appl. No.: 09/867,056

(22) Filed: May 29, 2001

(51) Int. Cl. G06F 11/30

(52) U.S. Cl. 713/200; 711/6

(57) ABSTRACT

A method and system for structuring an object in security policies of a computer system includes: receiving a request to access a virtual volume with a virtual name; mapping the virtual name to the real object; and providing the real object. The method and system uses virtual objects which map to real objects in a computer system. The access control mediator grants or denies access to a virtual object using a discretionary or a mandatory policy. A virtual name is mapped to a real object. This mapping is transparent to the subject. In this manner, security policies can be enforced over objects stored in file systems without regard to the policies of the file systems. The system can also be used as a gateway to remote file systems built on top of existing file systems. These advantages provide more flexibility in controlling a subject's access to real objects.

### FIELD OF THE INVENTION

The present invention relates to computer systems, and more particularly to security in computer systems.

### BACKGROUND OF THE INVENTION

Security in access to data in computer systems is a consistent concern in the industry. Computer security comprises a set of conditions under which subjects can access objects. As used in this specification, “subjects” are people or users and “objects” are data. The set of conditions is called a “policy”. A policy describes which operations can be performed by which subjects on which objects.

There are two types of operations: read and write. If a subject can read an object, then the subject has “read rights” to the object. If a subject can write an object, then the subject has “write rights” to the object. If the subject has read and/or write rights to an object, then the subject has “rights” to the object.

An access control mediator enforces the security policy of a computer system. The access control mediator is typically software which reviews a subject's rights to any object and determines if the access is granted or denied based on the system's security policy. The system security policy may be a discretionary or a mandatory policy.

A discretionary policy is a policy in which a security administrator determines a subject's rights to objects at the administrator's discretion. A mandatory policy is a policy in which the security administrator gives an object a sensitivity label or classification, and a trust level or clearance level. If the subject's trust level dominates, i.e., is greater than or equal to, the sensitivity level of the object, then the subject has rights to the object. Otherwise, the subject has no rights to the object.

Typically, an object is a file in a file system. Subjects are given rights to particular files in the file system. Other examples of objects include, but are not limited to, printers, modems and other devices, and emails, chat messages and other communications. However, to implement the security policies, the file system structures may need to be rebuilt or copied in order to set the proper flags reflecting these policies. This is cumbersome, especially when only a subset of a file system is shared. In addition, the subject is aware of the file system structure and the file names within it. Even if the subject has no rights to a file, he/she can discover if the file exists because he/she knows its name, and the system will inform him/her that access to the file is either granted or denied.

Accordingly, there exists a need for an improved method and system for structuring an object in security policies of a computer system. The method and system should be easy to implement and easily administrated by one of ordinary skill in the art. The present invention addresses such a need.

### SUMMARY OF THE INVENTION

A method and system for structuring an object in security policies of a computer system includes: receiving a request to access a virtual volume with a virtual name; mapping the virtual name to the real object; and providing the real object. The method and system uses virtual objects which map to real objects in a computer system. The access control mediator grants or denies access to a virtual object using a discretionary or a mandatory policy. A virtual name is mapped to a real object. This mapping is transparent to the subject. In this manner, security policies can be enforced over objects stored in file systems without regard to the policies of the file systems. The system can also be used as a gateway to remote file systems built on top of existing file systems. These advantages provide more flexibility in controlling a subject's access to real objects.

### BRIEF DESCRIPTION OF THE FIGURES

FIG. 1 illustrates a preferred embodiment of a system for structuring an object in security policies of a computer system in accordance with the present invention.

FIG. 2 is a flowchart illustrating a preferred embodiment of a method for structuring an object in security policies of a computer system in accordance with the present invention.

FIG. 3 illustrates a first preferred embodiment of the mapping of a virtual volume to a real volume in the system for structuring an object in security policies of a computer system in accordance with the present invention.

FIG. 4 illustrates a second preferred embodiment of the mapping of a virtual volume to a real volume in the system for structuring an object in security policies of a computer system in accordance with the present invention.

FIG. 5 illustrates a third preferred embodiment of the mapping of a virtual volume to a real volume in the system for structuring an object in security policies of a computer system in accordance with the present invention.

FIG. 6 illustrates a fourth preferred embodiment of the mapping of a virtual volume to a real volume in the system for structuring an object in security policies of a computer system in accordance with the present invention.

### DETAILED DESCRIPTION

The present invention provides an improved method and system for structuring an object in security policies of a computer system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method and system in accordance with the present invention uses virtual objects which map to real objects in a computer system. The access control mediator grants or denies access to a virtual object under a discretionary or a mandatory policy. A virtual name is mapped to a real object. This mapping is transparent to the subject.

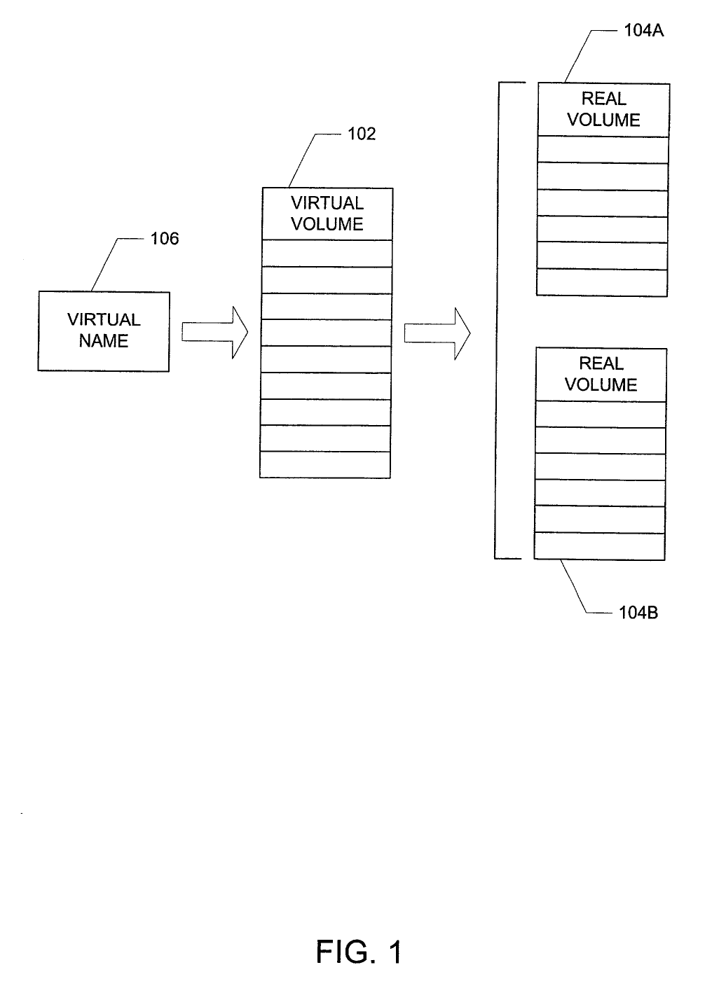

To more particularly describe the features of the present invention, please refer to FIGS. 1 through 6 in conjunction with the discussion below.

In the preferred embodiment, the security object is a virtual namespace referred herein as a “virtual volume”. The virtual volume contains one or more virtual objects, such as virtual files. The virtual files may be organized under virtual directories. FIG. 1 illustrates a preferred embodiment of a system for structuring an object in security policies of a computer system in accordance with the present invention. The system comprises a virtual volume 102. In the preferred embodiment, the subject is provided access to a virtual volume 102 as the security object. The virtual volume 102 comprises virtual files and/or virtual directories and one or more real volumes 104A-104B. The virtual files and/or directories map to real files and/or directories, respectively. A virtual name 106 is used to represent the real file. A subject only knows of the virtual name 106. The mapping to the real files is transparent to the subject. The real volumes 104A-104B can be on local file systems and/or remote file systems.

In the preferred embodiment, once the subject is determined to have rights to access the virtual volume 102, the subject has access to all of the virtual files in the virtual volume 102. For example, a first virtual volume is created which comprises virtual files and/or directories to which a subject with a certain clearance level has read rights. A second virtual volume is created which comprises virtual files and/or directories to which a subject with the certain clearance level has write rights. Once the access control mediator determines that a subject has read rights to access the first virtual volume, it does not need to check for read rights each time a virtual file in the first virtual volume is accessed. Once the access control mediator determines that a subject has write rights to access the second virtual volume, it does not need to check for write rights each time the subject wants to write to a virtual file in the second virtual volume.

Alternatively, one virtual volume for read rights may be created. The access control mediator determines that the subject has read rights to the virtual volume 102. When the subject sends a request to write to a virtual file in the virtual volume, the access control mediator determines if the subject has write rights to the virtual file. Other ways of creating virtual volumes are possible.

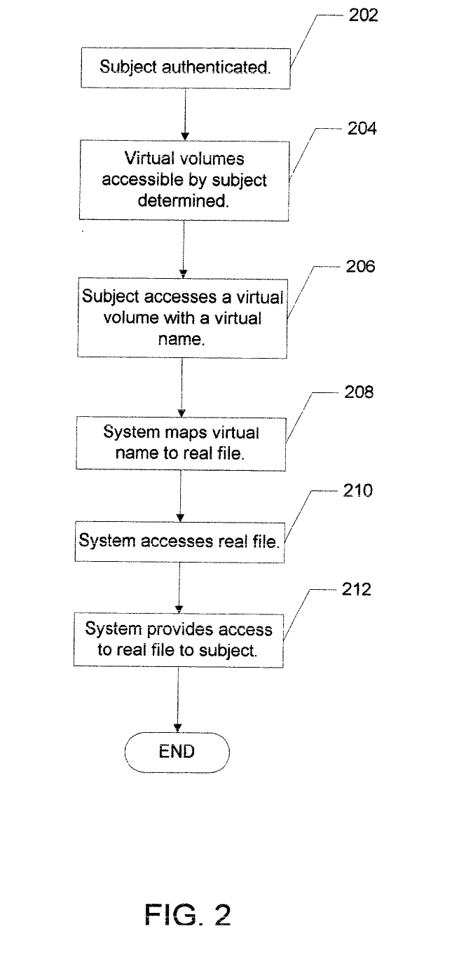

FIG. 2 is a flowchart illustrating a preferred embodiment of a method for structuring an object in security policies of a computer system in accordance with the present invention. First, the subject is authenticated, via step 202. Next, the virtual volume 102 accessible by the subject is determined, via step 204. In the preferred embodiment, a list of these virtual volumes is composed. When the subject accesses the virtual volume 102 with a virtual name 106, via step 206, the system maps the virtual name 106 to a real file in a real volume 104A or 104B, via step 208. The system then accesses the real file, via step 210, and provides the real file to the subject, via step 212. In the preferred embodiment, steps 208-212 are transparent to the subject. The subject is not aware of the real file name.

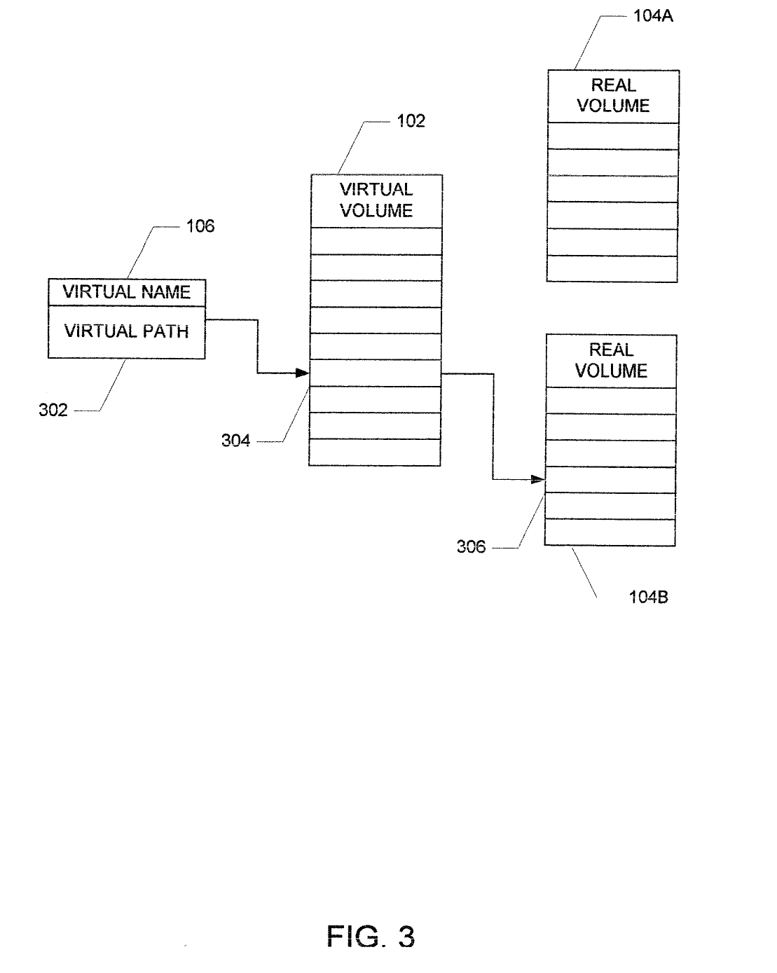

The mapping of the virtual volume to the real volume may be implemented in many different ways. FIG. 3 illustrates a first preferred embodiment of the mapping of a virtual volume to a real volume in the system for structuring an object in security policies of a computer system in accordance with the present invention. In this first preferred embodiment, a virtual file 304 points to a real file 306. The virtual name 106, which contains a virtual path 302, points to a virtual file 304 in the virtual volume 102. The virtual file 304 points to a real file 306 in a real volume 104B. Thus, assume that the subject is authenticated, via step 202, and is determined to have rights to access the virtual volume 102, via step 204. The subject then accesses the virtual volume 102 with the virtual name 106, via step 206. The virtual path 302 in the virtual name 106 points to the virtual file 304. Since the virtual file 304 points to the real file 306, the system maps the virtual name 106 to the real file 306, via step 208. The system accesses the real file 306, via step 210, and provides it to the subject, via step 212. The first preferred embodiment illustrates a one-to-one relationship between a virtual file and a real file.

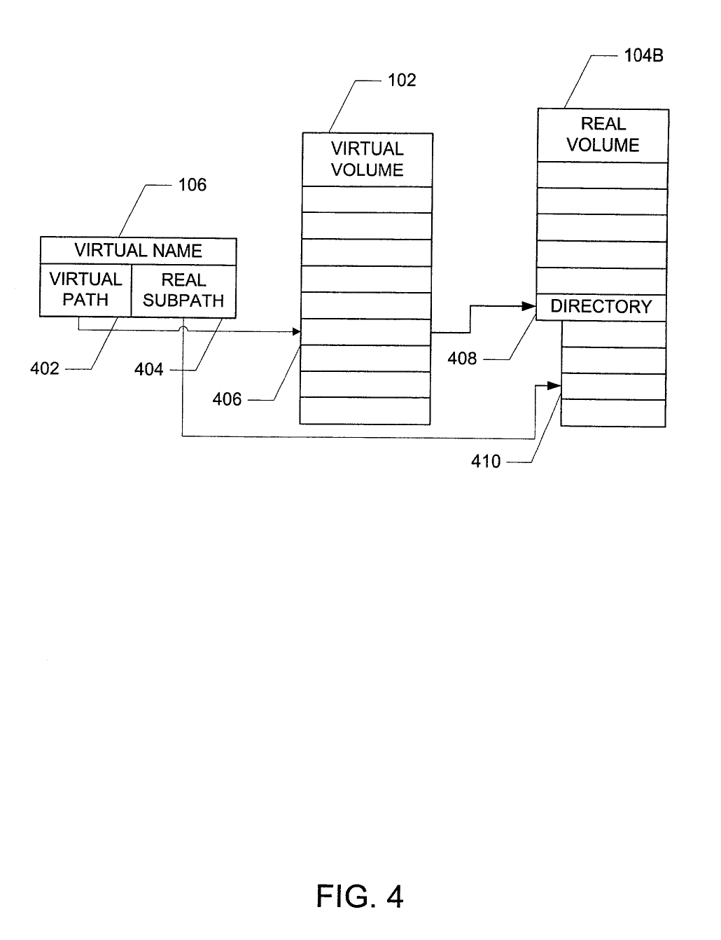

FIG. 4 illustrates a second preferred embodiment of the mapping of a virtual volume to a real volume in the system for structuring an object in security policies of a computer system in accordance with the present invention. In this second preferred embodiment, a virtual file 406 points to a real directory 408. The virtual name 106 contains a virtual path 402 and a real subpath 404. Thus, assume that the subject is authenticated, via step 202, and is determined to have rights to access the virtual volume 102, via step 204. The subject then accesses the virtual volume 102 with the virtual name 106, via step 206. The virtual path 402 in the virtual name 106 points to the virtual file 406. Since the virtual file 406 points to a real directory 408, the system uses the real subpath 404 to select the real file 410 under the real directory 408. The system maps the virtual name 106 to the real file 410, via step 208. The system accesses the real file 410, via step 210, and provides it to the subject, via step 212. The second preferred embodiment may be used in situations where a subject is to be granted access to all real files under a real directory. By granting rights to the real directory 408, rights are granted to all of the real files under that real directory 408.

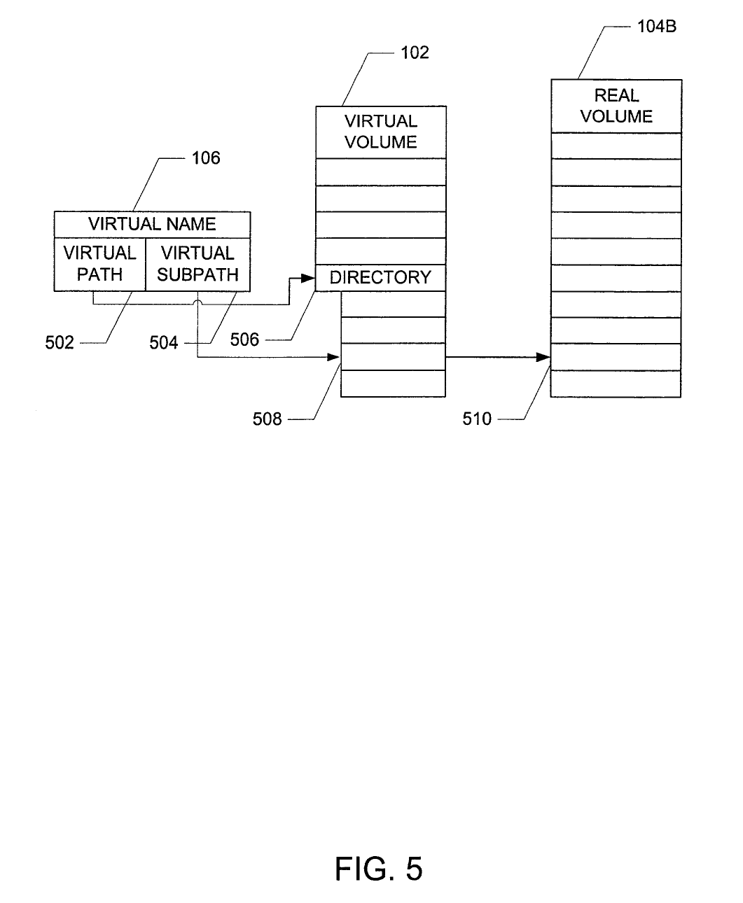

FIG. 5 illustrates a third preferred embodiment of the mapping of a virtual volume to a real volume in the system for structuring an object in security policies of a computer system in accordance with the present invention. In this third preferred embodiment, a virtual file 508 under a virtual directory 506 points to a real file 510. The virtual name 106 contains a virtual path 502 and a virtual subpath 504. Assume that the subject is authenticated, via step 202, and is determined to have rights to access the virtual volume 102, via step 204. The subject then accesses the virtual volume 102 with the virtual name 106, via step 206. The virtual path 502 points to the virtual directory 506 in the virtual volume 102. The virtual directory 506 has virtual files under it. The system uses the virtual subpath 504 in the virtual name 106 to select the virtual file 508 under the virtual directory 506. Since the virtual file 508 points to a real file 510, the system maps the virtual name 106 to the real file 510, via step 208. The system accesses the real file 510, via step 210, and provides it to the subject, via step 212. The third preferred embodiment may be used in situations where it is desirable to reorganize real files under a common virtual directory.

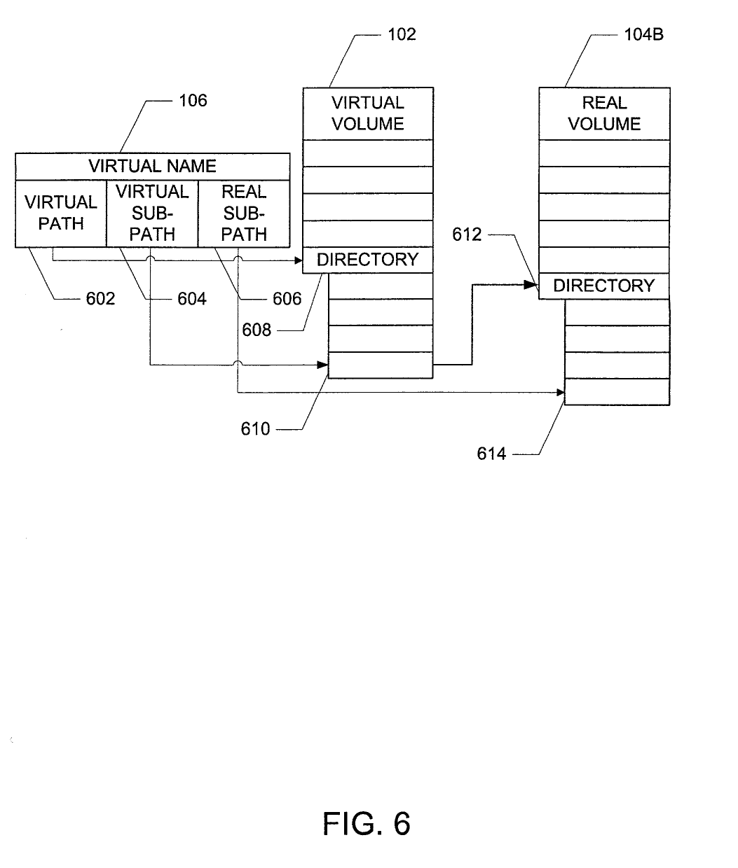

FIG. 6 illustrates a fourth preferred embodiment of the mapping of a virtual volume to a real volume in the system for structuring an object in security policies of a computer system in accordance with the present invention. In this fourth preferred embodiment, a virtual directory 608 points to a real directory 612. The virtual name 106 contains a virtual path 602, a virtual subpath 604, and a real subpath 606. Assume that the subject is authenticated, via step 202, and is determined to have rights to access the virtual volume 102, via step 204. The subject then accesses the virtual volume 102 with the virtual name 106, via step 206. The virtual path 602 points to the virtual directory 608 in the virtual volume 102. The virtual directory 608 has virtual files under it. The system uses the virtual subpath 604 in the virtual name 106 to select the virtual file 610 under the virtual directory 608. Since the virtual file 610 points to a real directory 612, the system uses the real subpath 606 to select the real file 614 under the real directory 612. The system then maps the virtual name 106 to the real file 614, via step 208. The system accesses the real file 614, via step 210, and provides it to the subject, via step 212.

Each virtual volume may contain any combination of the mappings illustrated in FIGS. 3-6. For example, the virtual volume 102 can comprise a first virtual file which points to a real file, a second virtual file which points to a real directory, a first virtual directory which points to a real file, and/or a second virtual directory which points to a real directory. Any combination of the four preferred embodiments of mapping may be used. Also, other mapping methods may be used without departing from the spirit and scope of the present invention.

An improved method and system for structuring an object in security policies of a computer system has been disclosed. The method and system uses virtual objects which map to real objects in a computer system. The access control mediator grants or denies access to a virtual object using a discretionary or a mandatory policy. A virtual name is mapped to a real object. This mapping is transparent to the subject. In this manner, security policies can be enforced over objects stored in file systems without regard to what policies the file systems may or may not have. For example, a file system may be in a Windows NT® environment. Virtual volumes may be created to point to native files in the Windows NT environment without regard to the policies implemented by Windows NT. The method and system in accordance with the present invention can also be used as a gateway to remote file systems. For example, virtual volumes may be created on a laptop computer. The laptop computer can be connected to an intranet, exposing the files in the intranet to subjects through the virtual volumes. In addition, the method and system in accordance with the present invention may be built on top of existing file systems. Thus, if virtual volumes are changed to reflect changes in a security policy, the real files need not be changed. Similarly, if real files are changed, the virtual volumes may be changed such that a subject is not aware of the change in the real file. These advantages provide more flexibility in controlling a subject's access to real objects.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing access control to a real object in a computer system, comprising the steps of:
(a) receiving a request to access a virtual volume with a virtual name;
(b) mapping the virtual name to the real object; and
(c) providing the real object.

2. The method of claim 1, wherein prior to the receiving step (a) comprises:
(a1) authenticating a subject; and
(a2) determining that the subject has a right to access the virtual volume.

3. The method of claim 1, wherein the mapping step (b) comprises:
(b1) determining that a virtual path in the virtual name points to a virtual object in the virtual volume; and
(b2) determining that the virtual object points to the real object.

4. The method of claim 1, wherein the mapping step (b) comprises:
(b1) determining that a virtual path in the virtual name points to a virtual object in the virtual volume;
(b2) determining that the virtual object points to a real directory; and
(b3) determining that a real subpath in the virtual name points to the real object under the real directory.

5. The method of claim 1, wherein the mapping step (b) comprises:
(b1) determining that a virtual path in the virtual name points to a virtual directory in the virtual volume;
(b2) determining that a virtual subpath in the virtual name points to a virtual object under the virtual directory; and
(b3) determining that the virtual object points to the real object.

6. The method of claim 1, wherein the mapping step (b) comprises:
(b1) determining that a virtual path in the virtual name points to a virtual directory in the virtual volume;
(b2) determining that a virtual subpath in the virtual name points to a virtual object under the virtual directory;
(b3) determining that the virtual object points to a real directory; and
(b4) determining that a real subpath in the virtual name points to the real object under the real directory.

7. A method for providing access control to a real object in a computer system, comprising the steps of:
(a) receiving a request to access a virtual volume with a virtual name, wherein the virtual name comprises a virtual path;
(b) determining that the virtual path points to a virtual object in the virtual volume;
(c) determining that the virtual object points to the real object; and
(d) providing the real object.

8. A method for providing access control to a real object in a computer system, comprising the steps of:
(a) receiving a request to access a virtual volume with a virtual name, wherein the virtual name comprises a virtual path and a real subpath;
(b) determining that the virtual path points to a virtual object in the virtual volume;
(c) determining that the virtual object points to a real directory;
(d) determining that the real subpath points to the real object under the real directory; and
(e) providing the real object.

9. A method for providing access control to a real object in a computer system, comprising the steps of:
(a) receiving a request to access a virtual volume with a virtual name, wherein the virtual name comprises a virtual path and a virtual subpath;
(b) determining that the virtual path points to a virtual directory in the virtual volume;
(c) determining that the virtual subpath points to a virtual object under the virtual directory;
(d) determining that the virtual object points to the real object; and
(e) providing the real object.

10. A method for providing access control to a real object in a computer system, comprising the steps of:
(a) receiving a request to access a virtual volume with a virtual name, wherein the virtual name comprises a virtual path, a virtual subpath, and a real subpath;
(b) determining that the virtual path points to a virtual directory in the virtual volume;
(c) determining that the virtual subpath points to a virtual object under the virtual directory;
(d) determining that the virtual object points to a real directory;
(e) determining that the real subpath points to the real object under the real directory; and
(f) providing the real object.

11. A system, comprising:
a virtual volume, comprising a virtual object;
a real volume, comprising a real object; and
a virtual name, wherein the virtual name is used to access the virtual object, wherein the virtual object is mapped to the real object.

12. The system of claim 11, wherein the virtual name comprises a virtual path,
wherein the virtual path points to the virtual object,
wherein the virtual object points to the real object.

13. The system of claim 11, wherein the real volume further comprises a real directory, wherein the real object is under the real directory,
wherein the virtual name comprises a virtual path and a real subpath,
wherein the virtual path points to the virtual object,
wherein the virtual object points to the real directory,
wherein the real subpath points to the real object.

14. The system of claim 11, wherein the virtual volume further comprises a virtual directory, wherein the virtual object is under the virtual directory,
wherein the virtual name comprises a virtual path and a virtual subpath,
wherein the virtual path points to the virtual directory,
wherein the virtual subpath points to the virtual object,
wherein the virtual object points to the real object.

15. The system of claim 11, wherein the virtual volume further comprises a virtual directory, wherein the virtual object is under the virtual directory,
wherein the real volume further comprises a real directory, wherein the real object is under the real directory,
wherein the virtual name comprises a virtual path, a virtual subpath, and a real subpath,
wherein the virtual path points to the virtual directory,
wherein the virtual subpath points to the virtual object,
wherein the virtual object points to the real directory,
wherein the real subpath points to the real object.

16. A computer readable medium with program instructions for providing access control to a real object in a computer system, comprising the instructions for:
(a) receiving a request to access a virtual volume with a virtual name;
(b) mapping the virtual name to the real object; and
(c) providing the real object.

17. The medium of claim 16, wherein prior to the receiving instruction (a) comprises instructions for:
(a1) authenticating a subject; and
(a2) determining that the subject has a right to access the virtual volume.

18. The medium of claim 16, wherein the mapping instruction (b) comprises instructions for:
(b1) determining that a virtual path in the virtual name points to a virtual object in the virtual volume; and
(b2) determining that the virtual object points to the real object.

19. The medium of claim 16, wherein the mapping instruction (b) comprises instructions for:
(b1) determining that a virtual path in the virtual name points to a virtual object in the virtual volume;
(b2) determining that the virtual object points to a real directory; and
(b3) determining that a real subpath in the virtual name points to the real object under the real directory.

20. The medium of claim 16, wherein the mapping instruction (b) comprises instructions for:
(b1) determining that a virtual path in the virtual name points to a virtual directory in the virtual volume;
(b2) determining that a virtual subpath in the virtual name points to a virtual object under the virtual directory; and
(b3) determining that the virtual object points to the real object.

21. The medium of claim 16, wherein the mapping instruction (b) comprises instructions for:
(b1) determining that a virtual path in the virtual name points to a virtual directory in the virtual volume;
(b2) determining that a virtual subpath in the virtual name points to a virtual object under the virtual directory;
(b3) determining that the virtual object points to a real directory; and
(b4) determining that a real subpath in the virtual name points to the real object under the real directory.

22. A computer readable medium with program instructions for providing access control to a real object in a computer system, comprising the instructions for:
(a) receiving a request to access a virtual volume with a virtual name, wherein the virtual name comprises a virtual path;
(b) determining that the virtual path points to a virtual object in the virtual volume;
(c) determining that the virtual object points to the real object; and
(d) providing the real object.

23. A computer readable medium with program instructions for providing access control to a real object in a computer system, comprising the instructions for:
(a) receiving a request to access a virtual volume with a virtual name, wherein the virtual name comprises a virtual path and a real subpath;
(b) determining that the virtual path points to a virtual object in the virtual volume;
(c) determining that the virtual object points to a real directory;
(d) determining that the real subpath points to the real object under the real directory; and
(e) providing the real object.

24. A computer readable medium with program instructions for providing access control to a real object in a computer system, comprising the instructions for:
(a) receiving a request to access a virtual volume with a virtual name, wherein the virtual name comprises a virtual path and a virtual subpath;
(b) determining that the virtual path points to a virtual directory in the virtual volume;
(c) determining that the virtual subpath points to a virtual object under the virtual directory;
(d) determining that the virtual object points to the real object; and
(e) providing the real object.

25. A computer readable medium with program instructions for providing access control to a real object in a computer system, comprising the instructions for:
(a) receiving a request to access a virtual volume with a virtual name, wherein the virtual name comprises a virtual path, a virtual subpath, and a real subpath;
(b) determining that the virtual path points to a virtual directory in the virtual volume;
(c) determining that the virtual subpath points to a virtual object under the virtual directory;
(d) determining that the virtual object points to a real directory;
(e) determining that the real subpath points to the real object under the real directory; and
(f) providing the real object.
